(19) United States
(12) Patent Application Publication
(10) Pub. No.: US 2016/0252227 A1
(43) Pub. Date: Sep. 1, 2016

(54) Signal Light

(71) Applicant: NOREP INTERNATIONAL, Saint-Jean-de-Braye (FR)

(72) Inventor: Bertrand VAN DEN BROEK, Guilly (FR)

(21) Appl. No.: 15/029,131

(22) PCT Filed: Oct. 13, 2014
(86) PCT No.: PCT/FR2014/052602

§ 371 Date: Apr. 13, 2016

(30) Foreign Application Priority Data
Oct. 14, 2013 (FR) 1359947

(51) Int. Cl. F21S 8/10; B60Q 1/30; B60Q 1/26

(52) U.S. Cl. CPC F21S 48/212; B60Q 1/2615; B60Q 1/305; F21S 48/33; F21S 48/215; F21W 2101/14

(57) ABSTRACT

A signal light (1) for a trailer; comprised of a housing (2); a connecting plate (7) which is disposed in the interior of the housing; means of illumination (4) which are electrically connected to the connecting plate; and at least one connector which is electrically connected to the connecting plate and which projects outwardly from the housing to allow the connector to be connected to another compatible connector.

The present invention relates to a signal light for a trailer.

A trailer requires signal lights which are electrically connected to a towing vehicle (e.g. tractor), so that other operators can perceive the location of the trailer, particularly at night or under fog conditions, and can be informed of the actions of the driver of the towing vehicle, particularly when braking or preparing to turn.

Generally, signal lights are connected to a light of the towing vehicle with wires and connectors. Connections between two signal lights require further customisation of the wiring.

This solution has the drawback of being complicated to realise for the user, who must remove the signal light, familiarise himself/herself with the cabling and then correctly connect each wire.

This solution has drawbacks for the manufacturer, who must develop and assemble different signal lights for each application.

Moreover, this solution does not allow for the use of signal lights with good water-tightness (signal lights which are well sealed).

There is thus a need for signal lights which are simpler to manufacture and install, and which have an improved seal.

The present invention satisfies this need.

For this purpose, according to the invention, a signal light is proposed which is comprised of:

a housing;

a connecting plate which is disposed in the interior of the housing;

means of illumination which are electrically connected to the connecting plate;

at least one connector which is electrically connected to the connecting plate and which projects outwardly from the housing to allow the connector to be connected to another compatible connector.

The connecting plate may be comprised of an etched, printed circuit disposed on the two faces of the connecting plate.

According to one embodiment of the invention, the lighting means comprise light-emitting diodes, e.g. so-called “surface-mounted devices” (SMDs).

The aforementioned at least one connector may be configured so as to enable a water-tight (sealed) connection with a compatible connector.

The signal light may further be comprised of fixing means which allow it to be fixed to the trailer. The fixing means comprise a dovetail-shaped groove disposed on the rear face of the housing.

If the signal light comprises a dovetail-shaped groove, a metallic piece may be provided which may be inserted into the dovetail-shaped groove. The metallic piece has a set of openings (orifices) which allow the accommodation of various fixing elements, e.g. fasteners such as screws and/or rivets.

According to the invention, a system of connection for a signal light for a trailer is also proposed, which is comprised of:
a connecting plate comprising at least one printed circuit;
at least one connector which is electrically connected to the connecting plate.

Other characteristics and advantages of the invention will be apparent from the following description, which is purely illustrative and should be read with reference to the accompanying drawings.

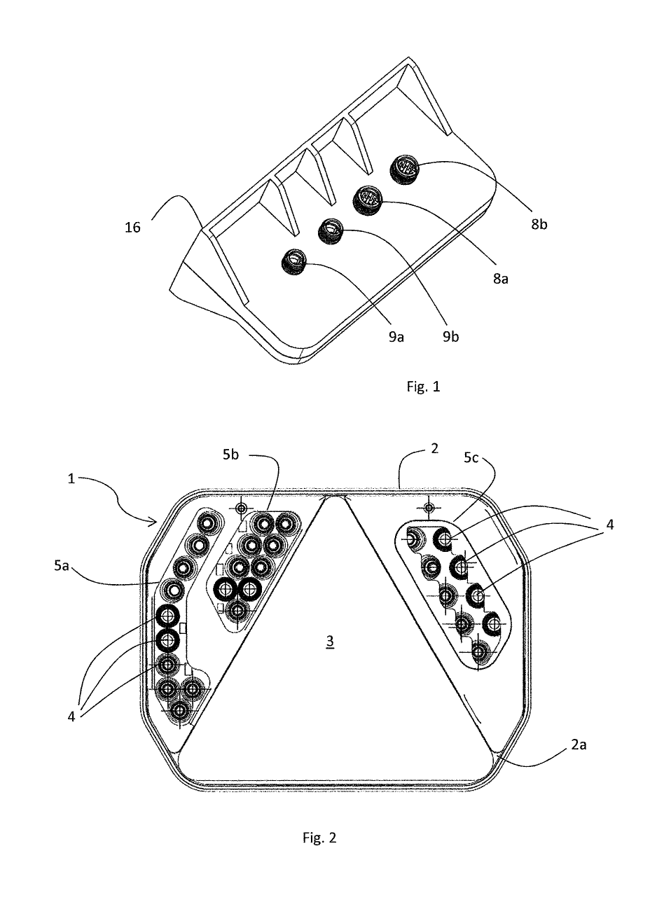

FIG. 1 of the drawings is a perspective view of a connecting plate for a signal light for a trailer according to one embodiment of the invention;

FIG. 2 is a plan view of a signal light according to one embodiment of the invention;

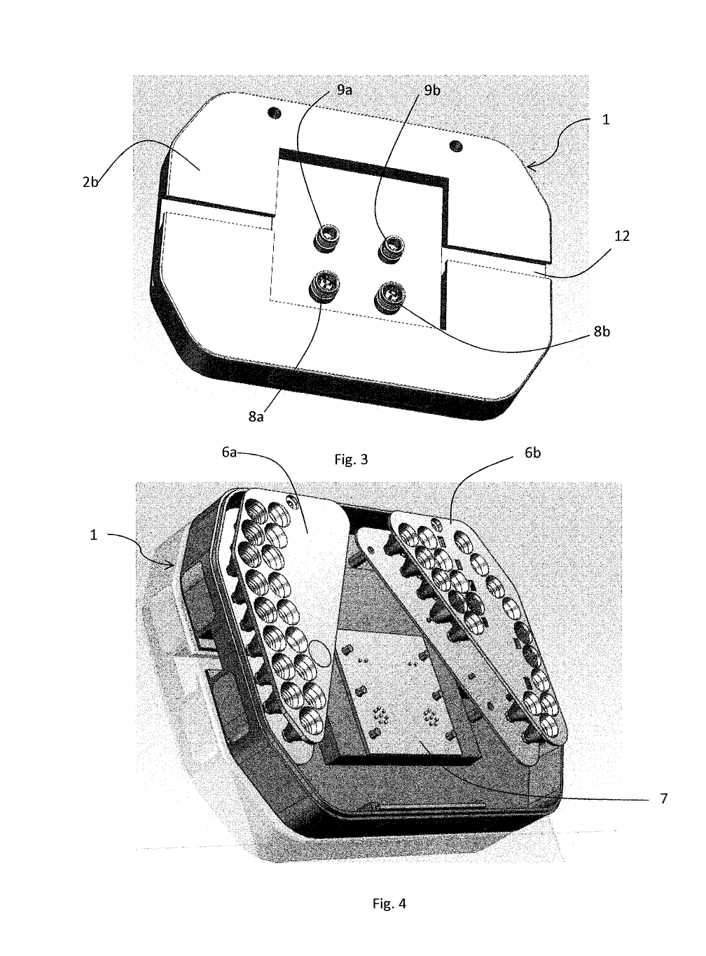

FIG. 3 is a perspective view showing the rear of the signal light according to FIG. 1;

FIG. 4 is a perspective view showing the interior of the signal light according to FIG. 1;

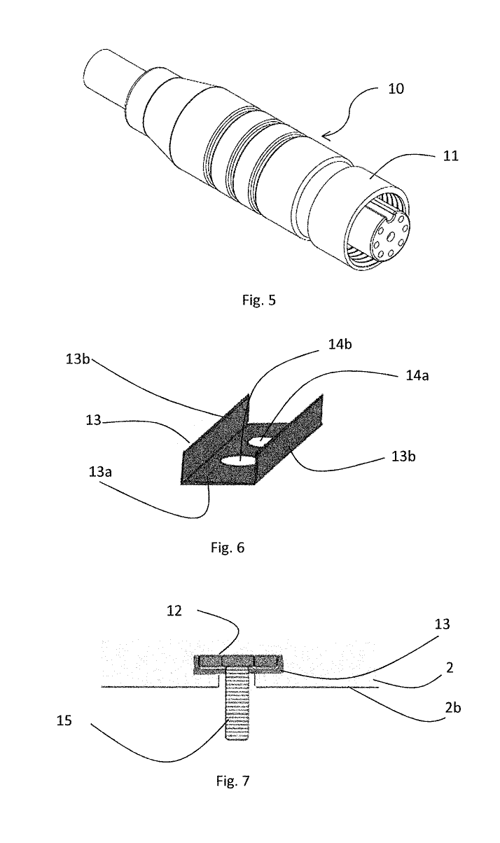

FIG. 5 is a perspective view showing an example of a male [sic] connector enabling connection of the signal light;

FIG. 6 is a perspective view of a metallic piece enabling the signal light to be fixed to a trailer; and

FIG. 7 is a transverse cross-sectional view showing the metallic piece according to FIG. 6 inserted into a groove in the housing of the signal light.

FIG. 1 shows a connecting plate for a signal light for a trailer.

The connecting plate comprises a printed circuit (not visible), which will also be referred to as [the] PCB (printed circuit board), and which is configured so as to provide power to the lighting means of the signal light.

If it is intended to mount a plurality of lights on the trailer, the connecting plate will be configured to provide power to the lighting means of all of the lights.

According to the embodiment illustrated in FIG. 1, the connecting plate is inserted in a body 16. The body 16 has a front face and a rear face, which are realised in moulded plastic material, for example. The front and rear faces are interconnected, preferably by water-tight (sealed) means. The means of fixing used are, e.g., ultrasonic welding, which allows a degree of sealing with an IP 69K protection rating.

Connectors, e.g. two eight-way female [sic] connectors 8a and 8b, and two two-way female [sic] connectors 9a and 9b, are connected to the connecting plate.

The outer shafts of the connectors are directly soldered (or welded) to the connecting plate, allowing one to obtain a connecting body 16 which is very compact.

Each connector 8a, 8b, 9a, 9b projects outward from the body 16 in order to enable it to be connected to a compatible male [sic] connector, so as to electrically connect the body 16 to one or more lights and/or to the trailer.

FIGS. 2 and 3 illustrate the front and rear views, respectively, of a signal light 1.

The light 1 is intended to be mounted on a trailer. The term “trailer” is understood here to mean any vehicle intended to be hitched to another vehicle. The trailer may be, e.g., a baggage trailer, industrial trailer, car-drawn trailer, motorcycle trailer, boat trailer, agricultural trailer or lorry trailer.

The light 1 may be, e.g., a left signal light. Right or lateral signal lights may be

realised in a similar manner, and thus will not be described in detail.

The light 1 has a housing 2. The housing 2 has a front face 2a which is transparent, and a rear face 2b which may be opaque. The front and rear faces 2a and 2b may be realised, e.g., in moulded plastic material. The front and rear faces 2a and 2b are fixed together, preferably in a water-tight (sealed) manner. This fixing is achieved, e.g., by ultrasonic welding, which enables one to achieve a degree of sealing with an IP 69K protection rating.

The light 1 has a signalling triangle 3 disposed in the interior of the housing 2, at the right [sic] of the front face 2a.

The light 1 further comprises illumination means disposed inside the housing 2, at the right [sic] of the front face 2a.

According to the embodiment illustrated, the illumination means comprise light-emitting diodes (LEDs) 4, e.g. so-called “surface-mounted devices” (SMDs).

The LEDs 4 are disposed to form signalling zones corresponding to the desired functions for the light 1. According to the embodiment of the invention illustrated in FIG. 1, a zone 5a corresponds, e.g., to the functions of stopping, flashing and night lighting, a zone 5b corresponds, e.g., to the function backing up, and a zone 5c corresponds to the function fog lighting. It should be noted that the number of zones and their dispositions as illustrated are not limitative, and depend on particular applications.

An advantage of LEDs is their very low power consumption, which is on the order of eight to ten times lower than that of incandescent or halogen lamps. Thus, the means of power supply to them are simplified and economical.

Furthermore, the useful life of LEDs is ca. 20 times that of incandescent lamps. This allows one to realise a housing 2 which has higher water-tightness because it no longer [sic] needs to be opened for changing lamps.

In addition, LEDs 4 are resistant to vibrations and emit ca. ten times less heat than halogen lamps, which increases the service life of the light 1.

Also, the light obtained from LEDs 4 is instantaneous, in contrast to the light from a filamentous lamp, which takes several tenths of a second to appear. This improves safety because braking, e.g., is signalled more rapidly.

Furthermore, LEDs 4 have reduced dimensions, affording additional space in the interior of the housing 2 and/or allowing the realisation of a light 1 which is more compact.

In addition, LEDs 4 have a good colour rendering index (CRI) and are monochromatic, which enhances their visibility.

FIG. 4 illustrates the interior of a signal light 1. The means of illumination have reflectors 6a and 6b which facilitate orientation of the light beams emitted by the LEDs 4, so as to control the angles and the power of the illumination.

The light 1 has a connecting plate 7 similar to the connecting plate described above. The connecting plate 7 is disposed in the interior of the housing 2, behind the illumination means.

The connecting plate 7 may be realised in the form of a printed circuit board (PCB).

The LEDs 4 are electrically connected to the connecting plate 7.

The PCB has a plurality of tracks, which are realised, e.g., by etching on the two surfaces of the connecting plate 7.

The connecting plate 7 has the function of supplying power to the LEDs 4, so as to facilitate various signalling functions of the light 1.

In a case where it is sought to mount a plurality of lights similar to the light 1 on a trailer, the connecting plate 7 of the light 1 also has information [sic] enabling the signalling functions of the other lights. Similarly, the connecting plate for each other light has all the information enabling the signalling functions of all the lights on the trailer.

The light 1 also has at least one female connector connected electrically to the connecting plate 7.

According to the embodiment of the invention illustrated in FIG. 3, the light 1 has two eight-way female [sic] connectors 8a and 8b, and two two-way female [sic] connectors 9a and 9b.

The outer shafts of the connectors are directly soldered (or welded) to the connecting plate 7, which enables one to obtain a very compact light 1.

Each connector 8a, 8b, 9a, 9b projects outward from the rear face 2b of the housing 2 in order to enable the connector to be connected to a compatible male connector, so as to electrically connect the light 1 to the trailer and/or to another light.

FIG. 5 illustrates an example of an eight-way male [sic] connector 10 that is compatible with the female connectors 8a and 8b. The connector 10 has a moulded outer part 11 which is realised, e.g., in a silicone and/or plastic material. The moulded part allows one to obtain a water-tight (sealed) connection with an IP 69K protection rating.

It is thus possible to realise a completely water-tight (sealed) light 1, which allows, in particular, high-pressure washing of the trailer on which the light 1 is mounted. Having a water-tight (sealed) light 1 is particularly of significance in the case of a trailer that needs to tolerate immersion, e.g. a boat trailer.

The light 1 also has fixing means, illustrated, e.g., in FIGS. 6 and 7.

The fixing means allow one to fix the light 1 to the trailer.

The fixing means comprise at least one groove 12 having a T shape or dovetail shape, disposed on the rear face 2b of the housing 2.

The groove 12 may also be seen in FIG. 3. According to the embodiment illustrated in FIG. 3, the groove 12 has two parts which extend on respective sides of the connectors 8a, 8b, 9a and 9b.

The groove 12 is intended to accommodate a set of metallic pieces 13, e.g. two such pieces 13. The dimensions of such a metallic piece 13 are adjusted such that the metallic piece 13 can be slid into the groove 12 up to one of the ends of the groove, but cannot be removed from the groove 12 through the narrow part ([e.g.] the narrow part of the dovetail configuration). The metallic piece 13 has, e.g., a central part 13a which is rectangular and two lateral parts 13b which extend perpendicularly to the central part 13a along two opposite sides of the central part 13a. The lateral parts 13b have a height which generally corresponds to, e.g., the height of the part of the groove 12 which forms the upper bar of the T.

The metallic piece 13 has one or more opening(s) (orifices), 14a and 14b, which permit engagement with the head of a fixing element 15. The fixing element 15 may be, e.g., a fastener such as a screw or rivet.

According to the embodiment illustrated in FIG. 6, the metallic piece 13 has two openings (orifices), 14a and 14b, which are of different dimensions. This allows the metallic piece 13 to be used with different fixing elements 15.

The fixing means described above are disposed exteriorly of the housing 2. Consequently, they allow the water-tightness of the housing 2 to be retained without application of a moulded outer part or other costly means.

Furthermore, the compatibility of the metallic piece 13 with different fixing elements 15 allows the user of the signal light 1 to choose the type and dimensions of the fixing elements which he/she wishes to employ.

In addition, the feature whereby the metallic pieces 13 can be situated by means of sliding allows one to adapt the fixing position and/or the distance between axes of fixing.

Also, no fixing element protrudes from the rear of the light 1 prior to the mounting [of the light], which facilitates storage of the light and limits the risk of breakage when lights collide during transportation.

The [process of] mounting of the light 1 to a trailer will now be described. This consists of accomplishing the electrical connection(s) of the light 1 and the fixing of the light 1 to the trailer.

The electrical connection can be accomplished with the aid of cables equipped with compatible male [sic] connectors. The cables can then be connected directly to the female [sic] connectors 8a, 8b, 9a and/or 9b [lit., “9c”], depending on the particular application.

A first cable may be connected to the connector 8a to connect the light 1 to the trailer, and a second cable may be connected to the connector 8b to connect the light 1 to another light.

For example, a first cable may be connected between the trailer and a left-side light to provide power for functions of left turn signalling, left night light, left fog light and stop signalling. Also, a second cable may be connected between the left light and a right light to provide power for functions of stop signalling, right turn signalling, right night light and signalling of backing up.

Other connections are possible, for example to provide power for functions of beacon lighting, lateral lighting, marker lighting, position lighting, etc.

This direct connection is possible because the connecting plate of each light mounted on the trailer has information [sic] allowing the signalling functions of all of the lights mounted on the trailer to be carried out.

A set of standard cables thus allows one to realise the various functions, in accordance with particular applications.

Thus the electrical connections are accomplished in a manner which is very simple for the user, who does not need to open the housing 2 or make the connections individually pin by pin.

The described means of connection also save time for the manufacturer because they facilitate customisation of the lights 1 and avoid the need to market a variety of products of smaller production volume.

To fix the light 1, the user inserts the fixing elements 15 of his/her choice into the metallic pieces 13.

Then the user situates the metallic pieces 13 equipped with fixing elements 15 into the groove 12, and slides them to the ends of the groove 12 [lit., “13”], until the desired position is reached in each instance.

Then the user fixes the light 1 to the trailer via the free ends of the fixing elements 15.

With this arrangement, the light 1 [lit., “15”] may be fixed very rapidly and without special tools.

Furthermore, the fixing process may be adapted to the fixing elements 15 which are available to the user, and to the trailer to which the light 1 is to be fixed.

It is understood that the present invention is not limited to the embodiments described hereinabove which have been presented by way of examples; it extends to other variants as well.

1. A signal light for a trailer comprised of:
a housing;
a connecting plate which is disposed in the interior of the housing;
means of illumination which are electrically connected to the connecting plate; and
at least one connector which is electrically connected to the connecting plate and which projects outwardly from the housing to allow the connector to be connected to another compatible connector.

2. The signal light according to claim 1, wherein the connecting plate is comprised of a printed circuit.

3. The signal light according to claim 2, wherein the printed circuit is realised by etching and is disposed on the two faces of the connecting plate.

4. The signal light according to claim 1, wherein the lighting means are comprised of light-emitting diodes.

5. The signal light according to claim 4, wherein the light-emitting diodes are SMDs (surface-mounted devices).

6. The signal light according to claim 1, wherein said at least one connector is configured to allow a water-tight (sealed) connection with a compatible connector.

7. The signal light according to claim 1, further comprising fixing means which allow the signal light to be fixed to the trailer; the fixing means have a dovetail-shaped groove which is disposed on the rear face of the housing.

8. The signal light according to claim 7, further comprising a metallic piece adapted to be inserted into the dovetail-shaped groove and being comprised of a plurality of openings (orifices) which permit the accommodation of various fixing elements.

9. A connecting system for a signal light for a trailer, comprised of:
a connecting plate comprising a printed circuit; and
at least one connector which is electrically connected to the connecting plate.

10. The signal light according to claim 8, wherein the fixing elements are screws and/or rivets.
